(19) United States
(12) Patent Application Publication
(10) Pub. No.: US 2009/0231417 A1
(43) Pub. Date: Sep. 17, 2009

(54) Protective Glasses

(75) Inventor: Jean Francois Demonchy, Gujan Mestras (FR)

Correspondence Address: Nixon Peabody LLP, 200 Page Mill Road, Palo Alto, CA, 94306, US

(73) Assignee: COMMISSARIAT A L'ENERGIE ATOMIQUE, Paris (FR)

(21) Appl. No.: 11/921,358

(22) PCT Filed: Jun. 6, 2006
(86) PCT No.: PCT/FR2006/050522

§ 371 Date: Nov. 30, 2007

(30) Foreign Application Priority Data
Jun. 7, 2005 (FR) 0551522

(51) Int. Cl. H04N 13/04

(52) U.S. Cl. 348/53; 348/E13.001

(57) ABSTRACT

The invention concerns eye protection glasses (17, 18) for an operator working in the vicinity of one or more sources of light radiation, comprising:
digital viewing glasses (10),
at least one video camera (11),
a command device (12) comprising a power supply (19),
two switchable video cameras:
a first, movement, video camera (40), used to view surroundings when moving in the environment,
a second, adjustment, video camera (41), used to view the working area.

### TECHNICAL AREA

The invention concerns eye protective glasses for an operator working in the vicinity of one or more visible or invisible light radiation sources, e.g. of laser type.

### STATE OF THE PRIOR ART

In the area of eye protection equipment against light radiation, suppliers of glasses offer solutions which are means for attenuating or passively reflecting this radiation, with no possible upgrading of these glasses in terms of the supply of ancillary services.

Also said solutions do not fully meet the needs of the invention:
Prior art protective glasses are only supplied for fixed wavelength ranges.
These protective glasses do not allow laser beams, which emit in the non-visible range, to be seen. They therefore require the use of an alignment laser beam in a wavelength other than working laser beam wavelengths.
These protective glasses are calibrated for certain power values. If these are high, this prevents good visibility of the environment which is of lower intensity.
These protective glasses, by achieving protection by reflection, generate a risk for other operators and even for surrounding equipment.
These protective glasses, even if properly calibrated, may be damaged by the received beams or by mechanical scratching. They then become potentially dangerous since such damage is not always perceptible. Regular inspection of these glasses is therefore necessary.
For certain power levels no effective eye protection glasses exist.

The object of the invention is to propose an interface between the operator's eyes and a source of external radiation, providing full eye protection irrespective of the wavelength or power of the radiation. However it does not concern the protection of said operator's eyes against the effects of a very high powered laser, such as a cutting laser.

### DESCRIPTION OF THE INVENTION

The invention concerns eye protection glasses for an operator in the vicinity of one or more light sources e.g. of laser type, comprising:
digital viewing glasses,
at least one video camera,
a command device with a power source,
   characterized in that they comprise two switchable video cameras:
a first movement video camera, to view surroundings when the operator moves within the environment,
a second video camera for adjustment, used to view the work area.

The digital viewing glasses may be virtual viewing glasses with double LCD display. The video camera may be a camera of <<pin-hole>> type, either CCD or CMOS.

The protective glasses of the invention may be coated with an absorbent coating.

In a first variant of embodiment, the command device also comprises a video transmitting unit able to transmit a go signal towards a remote processing unit.

In a second variant of embodiment, the command device also comprises a video receiving unit able to receive a return signal from a remote processing unit and to send this processed video signal to the digital viewing glasses.

The first video camera for movement may be a CCD camera for example with a wide view angle, large field depth and functioning in the visible range.

The second video camera for adjustment may be a CCD camera for example with a viewing angle narrower than the first camera, a smaller field depth and functioning in the visible or non-visible ranges.

The protective glasses of the invention have numerous advantages compared with known protective glasses in the prior art:
They do not function by attenuating light intensity and do not disturb perception of surroundings when moving within the environment, to look for equipment, take notes, read procedures or any other actions performed by the operator e.g. in a laser room.
They remain effective irrespective of the wavelength and power of the radiation source. This avoids errors in the choice of protection to be used in a given installation.
They allow an operator to work in a laboratory using several lasers of different wavelengths.
They allow the viewing of some pulsed lasers, by taking advantage of the acquisition time of the sensor used in the video camera.
For high flows, these glasses can be coated with an absorbent coating which eliminates any reflection-related problems.
Through proper choice of the camera technology, it is possible to view the environment of an intense light source allowing the operator to perceive a very bright spot on the screen, but nonetheless maintaining a perfect view of the remainder of the environment. Any eye glare is therefore fully cancelled out.
Said glasses have a low manufacturing cost and are lightweight.
They allow operators to work directly on lasers emitting in wavelengths invisible to the human eye, without having to use ancillary alignment lasers. The video camera is able to capture these wavelengths which can be reproduced on the viewing screens of the glasses in a visible colour, without fully disturbing the remainder of the viewed spectrum.
The adding of a hertz transmission system allows the movements and actions of an operator to be monitored remotely. This function opens up numerous possibilities in the area of safety or the preserving of knowledge for example.

### BRIEF DESCRIPTION OF THE DRAWINGS

FIG. 1 schematically illustrates one embodiment of the protective glasses of the invention.

FIGS. 2, 3 and 4 illustrate three variants of embodiment of the protective glasses of the invention.

### DETAILED DESCRIPTION OF PARTICULAR EMBODIMENTS

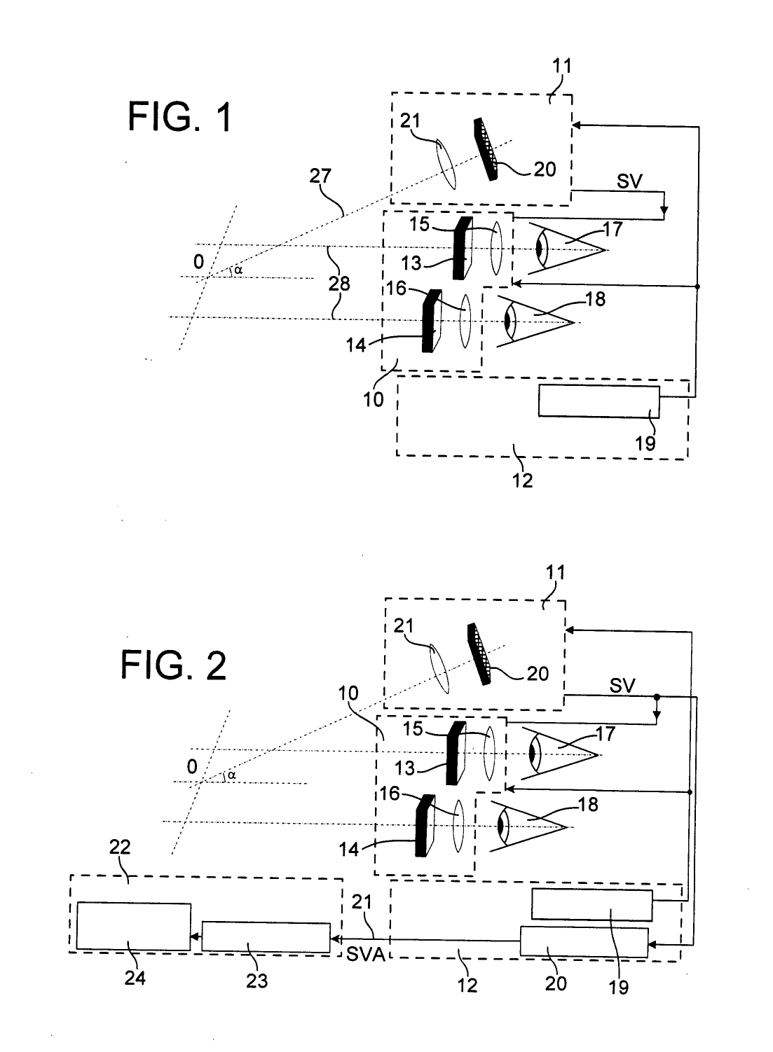

As illustrated in FIG. 1, the protective glasses of the invention comprise:
digital viewing glasses 10 arranged in front of the eyes 17 and 18 of an operator,
at least one video camera 11 directed towards the scene to be viewed (point 0), and which outputs a video signal SV towards these glasses 10,
a command device 12 comprising the power supply 19 for these glasses 10 and camera 11, which can be worn on the operator's belt.

The glasses 10 and the video camera are both oriented towards one same point 0. The angle a between the direction 27 perpendicular to the cell 20 of the camera, and the direction 28 perpendicular to the screens 13 and 14 of the glasses, illustrated in FIG. 1, can be adjusted in relation to the working distance.

In these glasses 10, to simulate 3D viewing at working distance, the angle a must be a nonzero angle.

The digital viewing glasses 10 are virtual vision glasses originally dedicated to a games use (game console or portable DVD player).

These glasses 10 therefore comprise a screen (13, 14) associated with a lens (15, 16) in front of each eye (17, 18) of the operator, each screen receiving the signal SV.

Said glasses 10 allow immersion in a virtual scene.

The video camera 11 may be a CCD camera (<<Charge Coupled Device>>) comprising a CCD sensor 20 in the form of a matrix of pixels, each of these pixels producing electrons when it receives photons. Here the sensor 20 is associated with a lens 21. The video camera 11 may also be a CMOS camera.

In a first variant of embodiment illustrated in FIG. 2, the command device 12, in addition to the power supply 19, comprises a video transmission unit 20 which transmits a go signal SVA, by hertz transmission or cable 21, to a video receiving unit 23 and a viewing and recording unit 24 located in a remote processing unit 22.

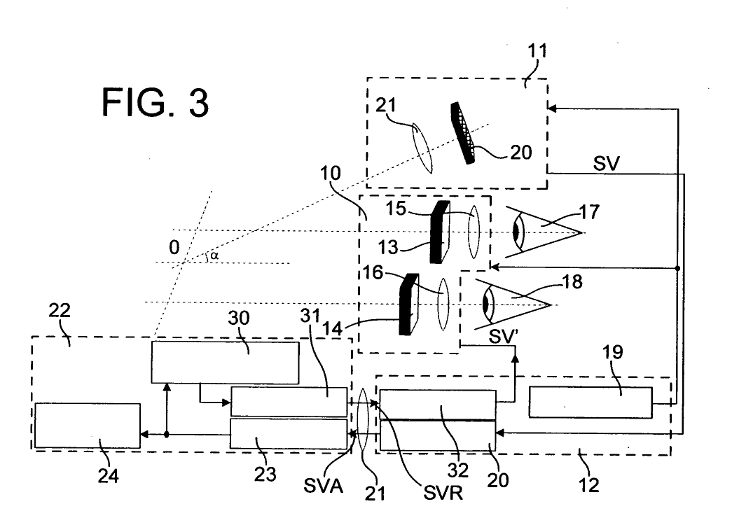

In a second variant of embodiment illustrated in FIG. 3, the remote processing unit 22, in addition to the elements illustrated in FIG. 2, comprises a real-time digital image processing unit 30, a video transmission unit 31 which transmits a return video signal SVR. The command device 12 comprises a video receiving unit 32 which receives this return signal SVR and whose output signal SV′ is sent to the digital viewing glasses 10.

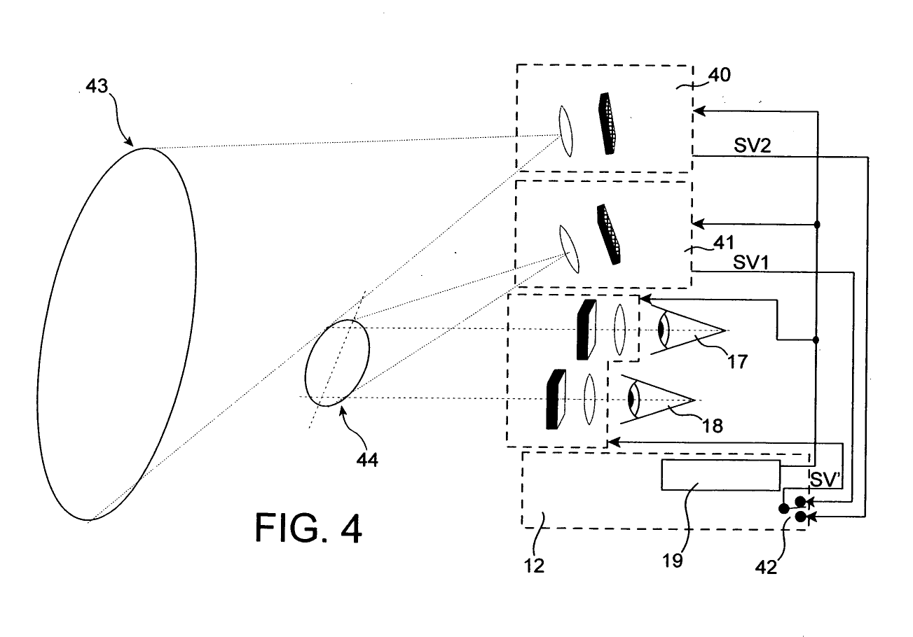

As illustrated in FIG. 4, the glasses of the invention use two video cameras which can be switched over:
a first video camera for movement 40 (wide angle view, large field depth, sensor in the visible range),
a second video camera for adjustment 41 (narrower viewing angle, smaller field depth, sensor in the visible or invisible range).

The first camera 40 is used to view the surroundings when moving within the environment. The second camera 41 is used to view the work area. Each camera outputs a video signal (SV1, SV2). In FIG. 4, the ellipse 43 illustrates the field of vision when moving within the environment. Ellipse 44 illustrates the working field of vision. In the glasses, the user is able to change over from one viewing mode to the other by means of a switch 42.

FIG. 4 does not illustrate the fact that this switch 42 is used to command powering of the camera that is in use, and to cut out the other camera for the purpose of preserving the lifetime of the power supply 19, consisting for example of rechargeable batteries.

### Example of Embodiment

In one example of embodiment, the constituent parts of the glasses of the invention are as follows.

The digital viewing glasses 10 are digital glasses with two LCD screens (Liquid Crystal Display) with a resolution of 180 000 pixels, which are positioned in front of each of the operator's eyes, and therefore having a double LCD display e.g. of the type <<RIMAX Virtual Vision 2-0>>.

The video camera 11 is a CCD camera with a <<pin-hole>> lens, for example a camera of <<Snake CCD Camera>> type manufactured by MISUMI (MS-C493A-3C-P01). The positioning of this camera is calculated to obtain maximum precision at a distance corresponding to a reading distance (eye/book). This choice of the <<pin-hole>> characteristic is made to obtain maximum depth of field.

The glasses 10+camera 11 assembly can be coated with an absorbent coating.

The powering 19 of these glasses 10 and of the video camera 11 is obtained using rechargeable batteries which can be worn on the operator's belt. The protective glasses of the invention are therefore fully self-powered. Said viewing assembly is neither more cumbersome, nor any heavier than some prior art protective glasses.

Said protective glasses can be used in particular as protective glasses by persons using lasers of a class higher than 2, by arc welders, by operators working in the vicinity of a furnace.

In general said protective glasses can be used for protection against any light radiation which may be detrimental to eye integrity, or in any areas in which possible glare carries a risk.

In addition, with said protective glasses it is possible to view invisible wavelengths.

1. Eye protection glasses (17, 18) for an operator in the vicinity of one or more sources of light radiation, comprising:
digital viewing glasses (10),
at least one video camera (11),
a command device (12), which comprises a power source (19),
characterized in that they comprise two switchable video cameras:
a first video camera for movement (40) used to view surroundings when moving within the environment,
a second video camera for adjustment (41), used to view the work area.

2. Glasses according to claim 1, in which the digital viewing glasses (10) are virtual viewing glasses with double LCD display.

3. Glasses according to claim 1, in which the video camera (11) is a CCD camera.

4. Glasses according to claim 1, in which the video camera (11) is a CMOS camera.

5. Glasses according to claim 1, in which the video camera (11) is a <<pin-hole>> camera.

6. Glasses according to claim 1, in which the video camera (11) is a camera equipped with a standard lens.

7. Glasses according to claim 1, which are coated with an absorbent coating.

8. Glasses according to claim 1, in which the command device (12) comprises a video transmission unit (20) able to transmit a go video signal (SVA) to a remote processing unit (22).

9. Glasses according to claim 8, in which the command device (12) comprises a video receiving unit (32) able to receive a return video signal (SVR) from the remote processing unit (22) and to send a video signal (SV′) to the digital viewing glasses (10).

10. Glasses according to claim 1, in which the first video camera (40) for movement is a video camera with a wide view angle, large field depth and functioning in the visible range.

11. Glasses according to claim 1, in which the second video camera (41) for adjustment is a video camera with a view angle narrower than the first camera, a smaller field depth and functioning in the range of visible or invisible wavelengths.

12. Glasses according to claim 1, in which the source or sources of radiation are one or more sources of laser type.
